(19) United States
(12) Patent Application Publication
(10) Pub. No.: US 2014/0323225 A1
(43) Pub. Date: Oct. 30, 2014

(54) SYSTEMS AND METHODS FOR SEGMENT-BASED CUSTOMIZATION FOR NOTIFICATIONS FOR USERS

(71) Applicant: Zynga Inc., San Francisco, CA (US)

(72) Inventor: Abhinav Agrawal, San Francisco, CA (US)

(73) Assignee: Zynga Inc., San Francisco, CA (US)

(21) Appl. No.: 14/260,634

(22) Filed: Apr. 24, 2014

Related U.S. Application Data
(60) Provisional application No. 61/815,672, filed on Apr. 24, 2013.

(51) Int. Cl. A63F 13/30

(52) U.S. Cl. CPC A63F 13/12
USPC 463/42

(57) ABSTRACT

A system, a non-transitory machine-readable storage medium storing instructions, and a computer-implemented method are described herein to create and send invitations to join an online game. An Notification Generator (NG) customizes message content based on detected online game account activities and relationships between various accounts associated with an online game. When the NG detects that an account is a new account or a lapsed account, the NG identifies an additional account(s) most likely to play the particular online game with the new/lapsed account. Some additional accounts may be social network system accounts while others may be online gaming system accounts. The NG groups the additional accounts according to account-type segments, and customizes online game invitation message with message content for a respective additional account based on the account-type segment and whether it has detected a new account or lapsed account.

### CROSS-REFERENCE TO RELATED APPLICATIONS

This application claims the priority benefit of U.S. Provisional Application No. 61/815,672, filed Apr. 24, 2013, which is incorporated herein by reference.

### TECHNICAL FIELD

The present disclosure generally relates to games and applications in general and, in particular embodiments, to computer-implemented multiplayer games, such as online social games hosted on a game server.

### BACKGROUND

In many computer-implemented games, there is a virtual world or some other imagined playing space where a player/user of the game controls one or more player characters (herein “character,” “player character,” or “PC”). Player characters can be considered in-game representations of the controlling player. As used herein, the terms “player,” “user,” “entity,” and “friend” may refer to the in-game player character controlled by that player, user, entity, or friend, unless context suggests otherwise. The game display can display a representation of the player character. In such cases, a game engine accepts inputs from the player, determines player character actions, decides outcomes of events and presents the player with a game display illuminating what happened. In some games, there are multiple players, wherein each player controls one or more player characters.

Gameplay may instead, or in addition, include player-initiated actions that are not PC-based. Some games, for example, provide for player placement and manipulation or non-character objects or elements on a virtual gameboard. Examples of such non-RPG games include word-based games where players place virtual letter tiles on a virtual gameboard grid to form scoring words, and card-based games, such Collectible Card Games (CCGs) and online poker-style games.

In many computer games, there are various types of in-game assets (aka “rewards” or “loot”) that a player character can obtain within the game. For example, a player character may acquire game points, gold coins, experience points, character levels, character attributes, virtual cash, game keys, or other in-game items of value. In many computer games, there are also various types of in-game obstacles that a player must overcome to advance within the game. In-game obstacles can include tasks, puzzles, opponents, levels, gates, actions, etc. In some games, a goal of the game may be to acquire certain in-game assets, which can then be used to complete in-game tasks or to overcome certain in-game obstacles. For example, a player may be able to acquire a virtual key (i.e., the in-game asset) that can then be used to open a virtual door (i.e., the in-game obstacle).

An electronic social networking system typically operates with one or more social networking servers providing interaction between users such that a user can specify other users of the social networking system as “friends.” A collection of users and the “friend” connections between users can form a social graph that can be traversed to find second, third and more remote connections between users, much like a graph of nodes connected by edges can be traversed.

Many online computer games are operated on an online social networking system. Such an online social networking system allows both users and other parties to interact with the computer games directly, whether to play the games or to retrieve game- or user-related information. Internet users may maintain one or more accounts with various service providers, including, for example, online game networking systems and online social networking systems. Online systems can typically be accessed using browser clients (e.g., Firefox, Chrome, Internet Explorer).

### BRIEF DESCRIPTION OF THE DRAWINGS

FIG. 1 is a schematic diagram showing an example of a system, according to some example embodiments.

FIG. 2 is a schematic diagram showing an example of a social network within a social graph, according to some embodiments.

FIG. 3 is a block diagram illustrating components of a game networking system, according to some example embodiments.

FIG. 4 is a flowchart showing an example method of automatically sending a message to an additional account, according to some example embodiments.

FIG. 5 is an example of a user interface of a client device, according to some example embodiments.

FIG. 6 is a flowchart showing an example method of automatically sending a message to an additional account selected from a listing by the lapsed account, according to some example embodiments.

FIGS. 7-9 are examples of user interfaces of a client device, according to some example embodiments.

FIG. 10 is a diagrammatic representation of an example data flow between example components of the example system of FIG. 1, according to some example embodiments.

FIGS. 11-12 are schematic diagrams showing an example network environment, in which various example embodiments may operate, according to some example embodiments.

### DETAILED DESCRIPTION

Example embodiments described herein include methods and systems to create and send invitations to join an online game. In an online game hosted by an online gaming system, some players access the online game via a social network account whereas other players access the game via an online gaming system account. According to example embodiments described herein, invitation messages to join an online game are customized based at least in part on whether the invitation message is being sent to a target social network account or a target online gaming system account. An invitation message sent to a target social network account will be populated with message content that is different than an invitation message being sent to a target online gaming system account. By customizing the invitation message according to the type of account to which it is being sent, the invitation message is populated with content that is most likely to entice a player to play the online game against another player.

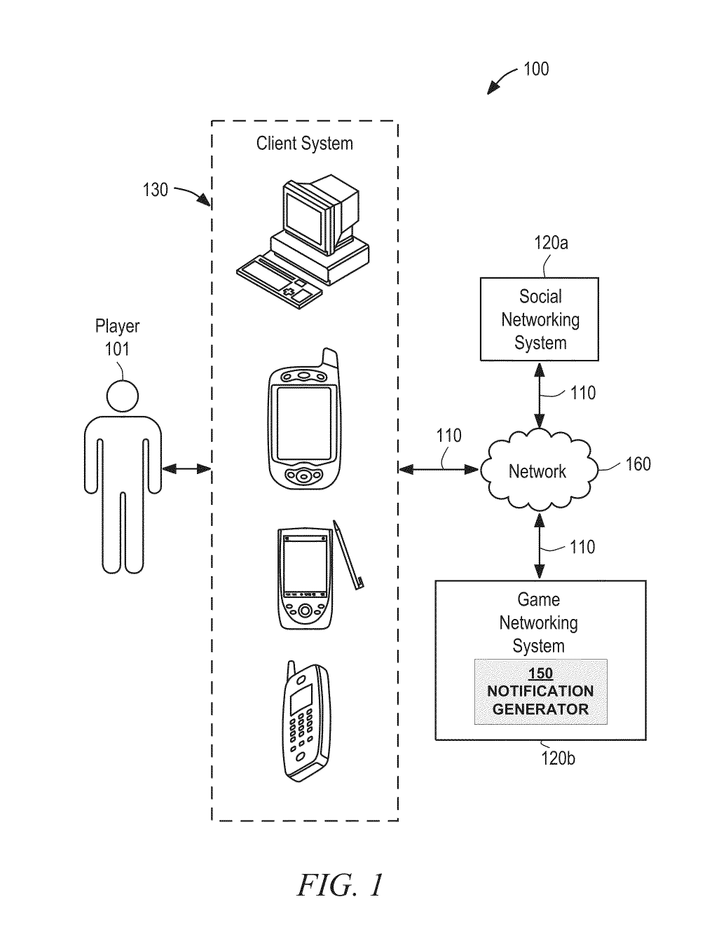

For example, in various embodiments, a Notification Generator (NG) 150, as shown in FIG. 1, is part of a game networking system 120b (i.e. online gaming system). The NG 150 detects a trigger event, such as detecting that a player's account has lapsed (“lapsed player”). Specifically, the NG 150 detects that the lapsed player has not played an online game within a predetermined time range. Based on detecting the trigger event, the NG 150 automatically identifies a plurality of additional accounts (i.e. target accounts). The NG 150 sorts the additional accounts according to account-type segments, where each additional account that is a social network account is associated with a first account-type segment and each additional account that is an online gaming system account is associated with a second-account type segment. It is understood that various embodiments can create account segments based on a variety of attributes other than (or in addition to) account type.

For each additional account, the NG 150 creates a customized invitation to play the online game against the lapsed player. If a respective additional account belongs to the first account-type segment (i.e. accesses the online game via a social network account), the NG 150 populates the invitation message with message content that emphasizes a social network relationship with the lapsed player. For example, in some embodiments, an invitation for a social network account to play the online game against the lapsed player may be based on the following text: “Play a game with your friend, <user_name>!—where <user_name> corresponds with the name of the lapsed player.

However, if a respective additional account belongs to the second account-type segment (i.e. accesses the online game via an online gaming system account), the NG 150 populates the invitation message with message content that emphasizes previous competition in the online game between the player and the lapsed player. For example, in some embodiments, an invitation for an online gaming system account that previously played the particular online game against the lapsed player may be based on the following text “When did you last play against <user_name>? Start a game now!”—where <user_name> corresponds with the name of the lapsed player.

### Social Network Systems and Game Networking Systems

FIG. 1 illustrates an example of a system for implementing various disclosed embodiments. In particular embodiments, system 100 comprises player 101, social networking system 120a, game networking system 120b (i.e. online gaming system), client system 130, and network 160. The components of system 100 can be connected to each other in any suitable configuration, using any suitable type of connection. The components may be connected directly or over a network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Social networking system 120a (i.e. social network system) is a network-addressable computing system that can host one or more social graphs. Social networking system 120a can generate, store, receive, and transmit social networking data. Social networking system 120a can be accessed by the other components of system 100 either directly or via network 160. Game networking system 120b is a network-addressable computing system that can host one or more online games. Game networking system 120b can generate, store, receive, and transmit game-related data, such as, for example, game account data, game input, game state data, and game displays. Game networking system 120b can be accessed by the other components of system 100 either directly or via network 160. Player 101 may use client system 130 to access, send data to, and receive data from social networking system 120a and game networking system 120b. Client system 130 can access social networking system 120a or game networking system 120b directly, via network 160, or via a third-party system. As an example and not by way of limitation, client system 130 may access game networking system 120b via social networking system 120a. Client system 130 can be any suitable computing device, such as a personal computer, laptop, cellular phone, smart phone, computing tablet, etc.

Although FIG. 1 illustrates a particular number of players 101, social network systems 120a, game networking systems 120b, client systems 130, and networks 160, this disclosure contemplates any suitable number of players 101, social network systems 120a, game networking systems 120b, client systems 130, and networks 160. As an example and not by way of limitation, system 100 may include one or more game networking systems 120b and no social networking systems 120a. As another example and not by way of limitation, system 100 may include a system that comprises both social networking system 120a and game networking system 120b. Moreover, although FIG. 1 illustrates a particular arrangement of player 101, social networking system 120a, game networking system 120b, client system 130, and network 160, this disclosure contemplates any suitable arrangement of player 101, social networking system 120a, game networking system 120b, client system 130, and network 160.

The components of system 100 may be connected to each other using any suitable connections 110. For example, suitable connections 110 include wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. Connections 110 need not necessarily be the same throughout system 100. One or more first connections 110 may differ in one or more respects from one or more second connections 110. Although FIG. 1 illustrates particular connections between player 101, social networking system 120a, game networking system 120b, client system 130, and network 160, this disclosure contemplates any suitable connections between player 101, social networking system 120a, game networking system 120b, client system 130, and network 160. As an example and not by way of limitation, in particular embodiments, client system 130 may have a direct connection to social networking system 120a or game networking system 120b, bypassing network 160.

### Online Games and Game Systems

Game Networking Systems

In an online computer game, a game engine manages the game state of the game. Game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs), and in-game objects. The game engine also manages game state, including player character state for currently active (online) and inactive (offline) players.

An online game can be hosted by game networking system 120b (i.e. online gaming system), which includes a Notification Generator 150 that performs operations according to embodiments as described herein. The game networking system 120b can be accessed using any suitable connection with a suitable client system 130. A player may have a game account on game networking system 120b, wherein the game account can contain a variety of information associated with the player (e.g., the player's personal information, financial information, purchase history, player character state, game state). In some embodiments, a player may play multiple games on game networking system 120b, which may maintain a single game account for the player with respect to all the games, or multiple individual game accounts for each game with respect to the player. In some embodiments, game networking system 120b can assign a unique identifier to each player 101 of an online game hosted on game networking system 120b. Game networking system 120b can determine that a player 101 is accessing the online game by reading the user's cookies, which may be appended to HTTP requests transmitted by client system 130, and/or by the player 101 logging onto the online game.

In particular embodiments, player 101 may access an online game and control the game's progress via client system 130 (e.g., by inputting commands to the game at the client device). Client system 130 can display the game interface, receive inputs from player 101, transmitting user inputs or other events to the game engine, and receive instructions from the game engine. The game engine can be executed on any suitable system (such as, for example, client system 130, social networking system 120a, or game networking system 120b). As an example and not by way of limitation, client system 130 can download client components of an online game, which are executed locally, while a remote game server, such as game networking system 120b, provides backend support for the client components and may be responsible for maintaining application data of the game, processing the inputs from the player, updating and/or synchronizing the game state based on the game logic and each input from the player, and transmitting instructions to client system 130. As another example and not by way of limitation, each time player 101 provides an input to the game through the client system 130 (such as, for example, by typing on the keyboard or clicking the mouse of client system 130), the client components of the game may transmit the player's input to game networking system 120b.

### Game Systems, Social Networks, and Social Graphs:

In an online multiplayer game, players may control player characters (PCs), a game engine controls non-player characters (NPCs) and game features, and the game engine also manages player character state and game state and tracks the state for currently active (i.e., online) players and currently inactive (i.e., offline) players. A player character can have a set of attributes and a set of friends associated with the player character. As used herein, the term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), etc. The game engine may use player character state to determine the outcome of game events, sometimes also considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each player.

In particular embodiments, player 101 may access particular game instances of an online game. A game instance is copy of a specific game play area that is created during runtime. In particular embodiments, a game instance is a discrete game play area where one or more players 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In particular embodiments, a game instance is populated by one or more player characters controlled by one or more players 101 and one or more in-game objects controlled by the game engine. When accessing an online game, the game engine may allow player 101 to select a particular game instance to play from a plurality of game instances. Alternatively, the game engine may automatically select the game instance that player 101 will access. In particular embodiments, an online game comprises only one game instance that all players 101 of the online game can access.

In particular embodiments, a specific game instance may be associated with one or more specific players. A game instance is associated with a specific player when one or more game parameters of the game instance are associated with the specific player. As an example and not by way of limitation, a game instance associated with a first player may be named “First Player's Play Area.” This game instance may be populated with the first player's PC and one or more in-game objects associated with the first player. In particular embodiments, a game instance associated with a specific player may only be accessible by that specific player. As an example and not by way of limitation, a first player may access a first game instance when playing an online game, and this first game instance may be inaccessible to all other players. In other embodiments, a game instance associated with a specific player may be accessible by one or more other players, either synchronously or asynchronously with the specific player's game play. As an example and not by way of limitation, a first player may be associated with a first game instance, but the first game instance may be accessed by all first-degree friends in the first player's social network. In particular embodiments, the game engine may create a specific game instance for a specific player when that player accesses the game. As an example and not by way of limitation, the game engine may create a first game instance when a first player initially accesses an online game, and that same game instance may be loaded each time the first player accesses the game. As another example and not by way of limitation, the game engine may create a new game instance each time a first player accesses an online game, wherein each game instance may be created randomly or selected from a set of predetermined game instances. In particular embodiments, the set of in-game actions available to a specific player may be different in a game instance that is associated with that player compared to a game instance that is not associated with that player. The set of in-game actions available to a specific player in a game instance associated with that player may be a subset, superset, or independent of the set of in-game actions available to that player in a game instance that is not associated with him. As an example and not by way of limitation, a first player may be associated with Blackacre Farm in an online farming game. The first player may be able to plant crops on Blackacre Farm. If the first player accesses game instance associated with another player, such as Whiteacre Farm, the game engine may not allow the first player to plant crops in that game instance. However, other in-game actions may be available to the first player, such as watering or fertilizing crops on Whiteacre Farm.

In particular embodiments, a game engine can interface with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player or player character in an online multiplayer game, though this disclosure any suitable social graph users.

The minimum number of edges required to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N−1 other users), they are deemed to be separated by N degrees of separation. This user would be a so-called “Nth-degree friend.” As used herein, the term “friend” means only first-degree friends, unless context suggests otherwise.

Within the social graph, each player (or player character) has a social network. A player's social network includes all users in the social graph within Nₘₐₓ degrees of the player, where Nₘₐₓ is the maximum degree of separation allowed by the system managing the social graph (such as, for example, social networking system 120a or game networking system 120b). In one embodiment, Nₘₐₓ equals 1, such that the player's social network includes only first-degree friends. In another embodiment, Nₘₐₓ is unlimited and the player's social network is coextensive with the social graph.

In particular embodiments, the social graph is managed by game networking system 120b, which is managed by the game operator. In other embodiments, the social graph is part of a social networking system 120a managed by a third-party (e.g., Facebook, Friendster, Myspace). In yet other embodiments, player 101 has a social network on both game networking system 120b and social networking system 120a, wherein player 101 can have a social network on the game networking system 120b that is a subset, superset, or independent of the player's social network on social networking system 120a. In such combined systems, game network system 120b can maintain social graph information with edge type attributes that indicate whether a given friend is an “in-game friend,” an “out-of-game friend,” or both. The various embodiments disclosed herein are operable when the social graph is managed by social networking system 120a, game networking system 120b, or both.

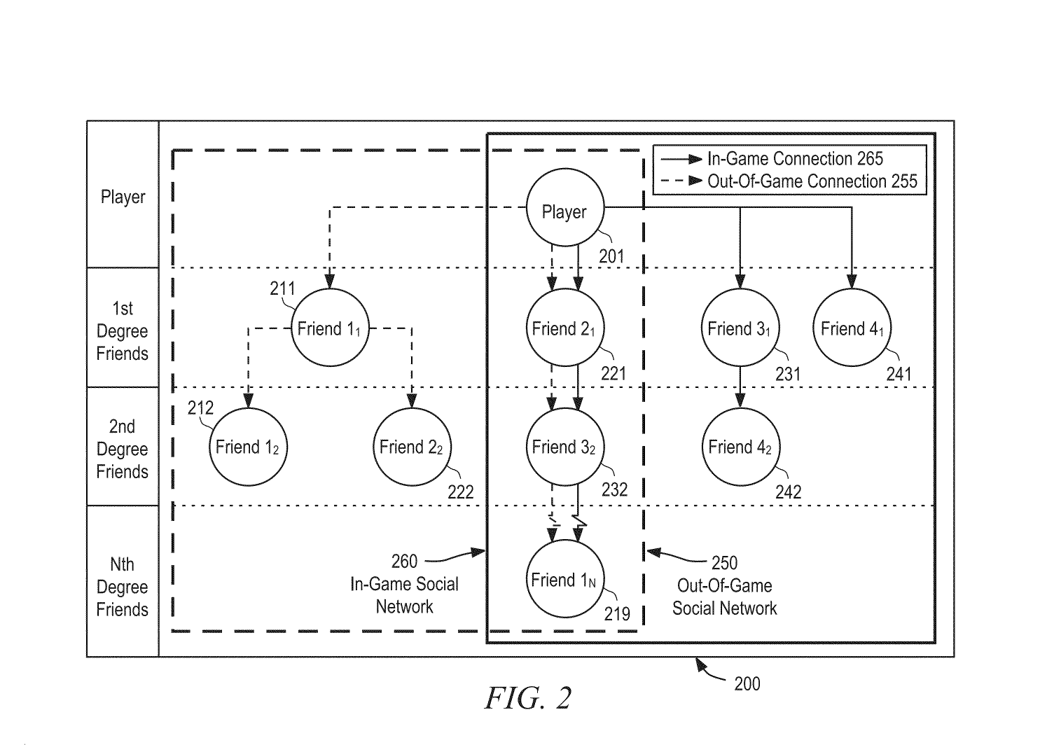

FIG. 2 shows an example of a social network within a social graph. As shown, Player 201 can be associated, connected or linked to various other users, or “friends,” within the social network 250. These associations, connections or links can track relationships between users within the social network 250 and are commonly referred to as online “friends” or “friendships” between users. Each friend or friendship in a particular user's social network within a social graph is commonly referred to as a “node.” For purposes of illustration and not by way of limitation, the details of social network 250 will be described in relation to Player 201. As used herein, the terms “player,” “user” and “account” can be used interchangeably and can refer to any user or character in an online game networking system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In social network 250, Player 201 has two first-degree friends. That is, Player 201 is directly connected to Friend 1₁ 211 and Friend 2₁ 221. In a social graph, it is possible for individuals to be connected to other individuals through their first-degree friends (i.e., friends of friends). As described above, each edge required to connect a player to another user is considered the degree of separation. For example, FIG. 2 shows that Player 201 has three second-degree friends to which he is connected via his connection to his first-degree friends. Second-degree Friend 1₂ 212 and Friend 2₂ 222 are connected to Player 201 via his first-degree Friend 1₁ 211. The limit on the depth of friend connections, or the number of degrees of separation for associations, that Player 201 is allowed is typically dictated by the restrictions and policies implemented by social networking system 120a.

In various embodiments, Player 201 can have Nth-degree friends connected to him through a chain of intermediary degree friends as indicated in FIG. 2. For example, Nth-degree Friend 1_{N} 219 is connected to Player 201 via second-degree Friend 3₂ 232 and one or more other higher-degree friends. Various embodiments may take advantage of and utilize the distinction between the various degrees of friendship relative to Player 201.

In particular embodiments, a player (or player character) can have a social graph within an online multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in his out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in his in-game social network 260. In some embodiments, it is possible for a friend to be in both the out-of-game social network 250 and the in-game social network 260. Here, Friend 2₁ 221 has both an out-of-game connection 255 and an in-game connection 265 with Player 201, such that Friend 2₁ 221 is in both Player 201's in-game social network 260 and Player 201's out-of-game social network 250.

As with other social networks, Player 201 can have second-degree and higher-degree friends in both his in-game and out of game social networks. In some embodiments, it is possible for Player 201 to have a friend connected to him both in his in-game and out-of-game social networks, wherein the friend is at different degrees of separation in each network. For example, if Friend 2₂ 222 had a direct in-game connection with Player 201, Friend 2₂ 222 would be a second-degree friend in Player 201's out-of-game social network, but a first-degree friend in Player 201's in-game social network. In particular embodiments, a game engine can access in-game social network 260, out-of-game social network 250, or both.

In particular embodiments, the connections in a player's in-game social network can be formed both explicitly (e.g., users must “friend” each other) and implicitly (e.g., system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in disintermediated interactions or the like), but that could be the case.

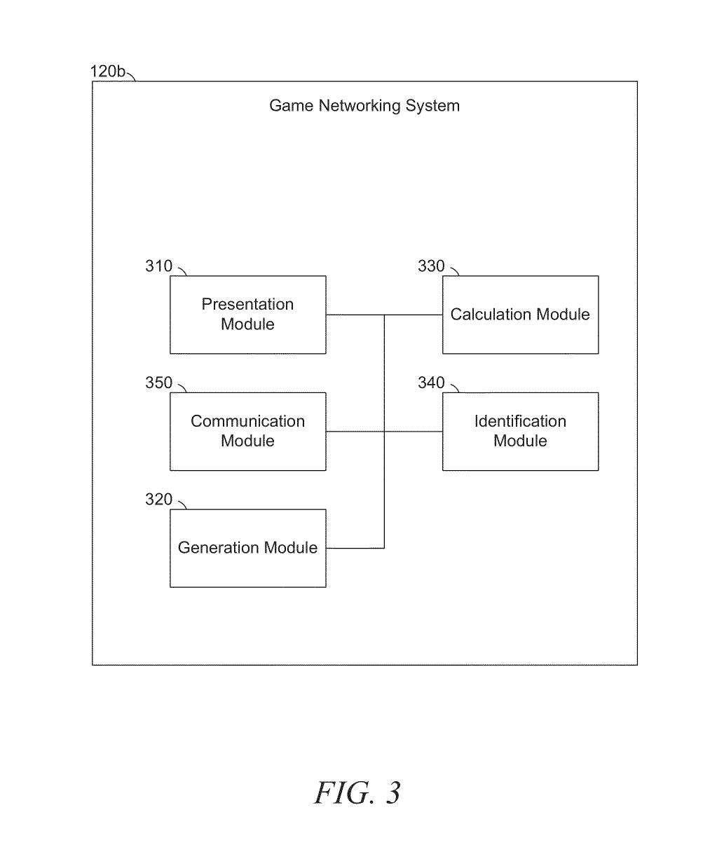

FIG. 3 is a block diagram illustrating components of a game networking system, according to some example embodiments. The game networking system 120b may include a presentation module 310, a generation module 320, a calculation module 330, an identification module 340, and an access module 350, a communication module 360.

In various example embodiments, the presentation module 310 is configured to present a user interface that is receptive to user input to trigger execution of a computer-implemented multiplayer online game. The user interface may be presented by the presentation module 310 to a client device 130. Moreover, the computer-implemented multiplayer online game may be playable via the client device by an associated player. The user interface presented on the client device 130 may receive user inputs from the player associated with the client device 130. For instance, the user interface may include a control that is operable to trigger execution of computer-implemented multiplayer online game. The computer-implemented multiplayer online game may have default game mechanics that govern gameplay according to a default set of game rules. In various example embodiments, the presentation module 310 may be further configured to present the computer-implemented multiplayer online game as data to be installed on the client device 130 that is playable via the client device 130 by the associated player. For instance, the computer-implemented multiplayer online game may be an application that is available for download from an online application store. Moreover, the user inputs received from the player may be sent as signals from the client device associated with the player.

In various example embodiments, the generation module 320 is configured to generate the default set of game rules that govern gameplay of the computer-implemented multiplayer online game. The default set of game rules may govern functionality of the computer-implemented multiplayer online game including at least one of asset types available in the multiplayer game, moves available in the multiplayer game, features available in the multiplayer game, and constraints associated with the multiplayer game.

In various example embodiments, the calculation module 330 is configured to calculate game statistics and game usage associated with each type of account that accesses the computer-implemented multiplayer online game. The calculation module 340 may perform this calculation during each one of the multiple regularly staggered intervals. Moreover, the calculated game statistics may be associated with the player. For example, the calculation module 340 may calculate a game score of the player based on the collected game data. The calculation module 340 may perform the calculation using a pre-defined function that uses the collected game data as inputs to the function.

In various example embodiments, the identification module 350 is configured to identify other players that are connected to the player within a social graph corresponding to the player. The social graph may be accessed from the social networking system 120a under a social network account associated with the player. Moreover, the identified users may each be friends of the player. A game statistic achieved by each of the identified users may be accessed by the access module 360, as further explained below.

In various example embodiments, the communication module 350 is configured to send online game invitation messages generated by the NG 150 to client devices 130 associated with various accounts that access the computer-implemented multiplayer online game(s) hosted by the game networking system 120b.

### Segment-Based Customized Notifications

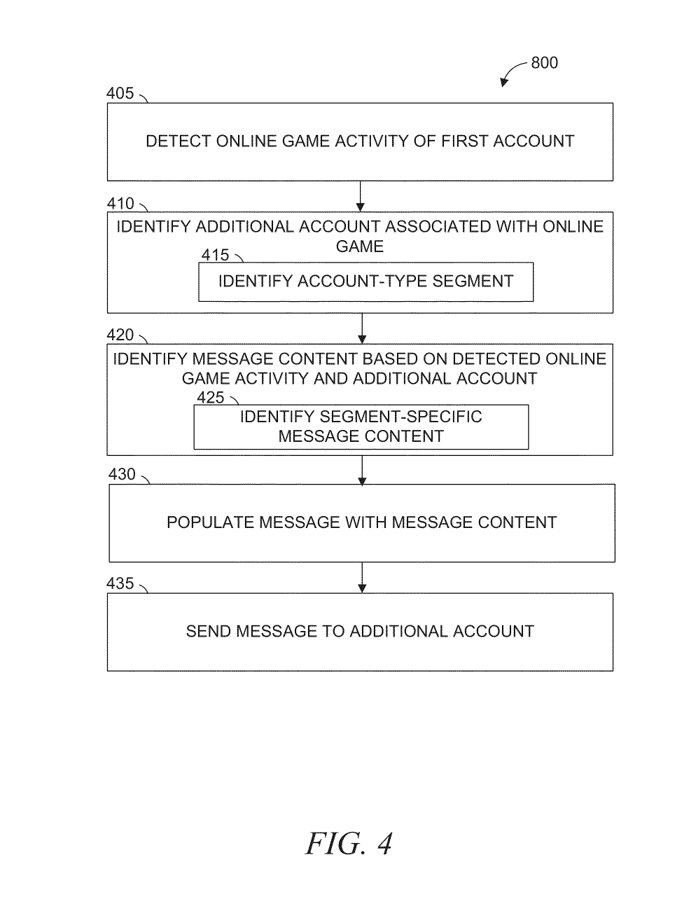

FIG. 4 is a flowchart showing an example method 400 of automatically sending a message to an additional account, according to some example embodiments. The steps in method 400 describe operations that may be performed by the game networking system 120b.

At step 405, the NG 150 detects online game activity of a first account (such as Player 201 in FIG. 2). The NG 150 may be configured to detect occurrence of a predefined trigger, such as a predefined trigger activity, a predefined trigger event and/or a predefined trigger time range. In some instances, the NG 150 may be configured to detect any one of a plurality of predefined triggers.

For example, in various embodiments, the NG 150 detects a predefined trigger event, such as an installation of the online game by the first account (such as Player 201 in FIG. 2). Based on the detected installation, the NG 150 determines the first account is a new account that has never previously accessed the online game. According to another example embodiment, the NG 150 determines the first account is a lapsed account based upon determining that the first account last accessed the online game at a time prior to a predetermined trigger time range. The predetermined trigger time range may be a predefined preceding threshold interval.

According to another example embodiment, trigger activity detected by the NG 150 may comprise lapsing of the first account, where such lapsing is indicated by below-threshold levels of in-game activity of the first account. The NG 150 may therefore be configured to identify lapsing of the first account based on satisfaction of predefined lapsing criteria.

At step 410, the NG 150 identifies an additional account associated with the online game. To identify an additional account, at step 415, the NG 150 identifies account-type segments. According to an example embodiment, the NG 150 identifies (i) a first segment of social network system account(s) that accesses the online game on an online gaming system and (ii) a second segment of online gaming system account(s) stored on the online gaming system.

For a first account-type segment, the NG 150 identifies a social network account(s) (such as Friend 211, Friend 212, Friend 222 in FIG. 2) based on the social network account(s) having a connection with an identity of the first account on a social networking system. The connection can be any type of connection that meets a threshold level of connection, such as a direct connection (i.e. first-degree), or an indirect connection (i.e. second-degree, third-degree, nth-degree). Instead, or in addition, the threshold level of connection may be determined based at least in part on an analysis of similarity of social network system activity of the first account and the respective additional accounts that are social network accounts.

For a second account-type segment, the NG 150 identifies an online gaming system account(s) based on the online gaming system account having previously played the online game and/or any other online game(s) against the first account. In another embodiment, the NG 150 identifies an online gaming system account(s) (such as Friend 231, Friend 241, Friend 242 in FIG. 2) that has a social graph connection with the first account in a social graph of online gaming system accounts within the online gaming system. The social graph connection can also be any type of connection that meets the threshold level of connection, such as a direct connection (i.e. first-degree), or an indirect connection (i.e. second-degree, third-degree, nth-degree).

At step 420, the NG 150 automatically identifies message content based on the detected trigger event (such as detected online game activity) and the additional account. According to an example embodiment, at step 425, the NG 150 automatically identifies segment-specific message content. For each respective identified additional account (i.e. respective target account), the NG 150 automatically identifies first segment content when a respective identified additional account is a social network system account and automatically identifies second segment content when a respective identified additional account is an online gaming system account. The first segment content differs from the second segment content.

At step 430, for each respective identified additional account, the NG 150 populates a message with the message content. According to an example embodiment, the NG 150 includes the first segment content or the second segment content as part of the message content for an instance of an online game invitation to be sent to the respective identified additional account.

At step 435, the NG 150 sends the message to the additional account.

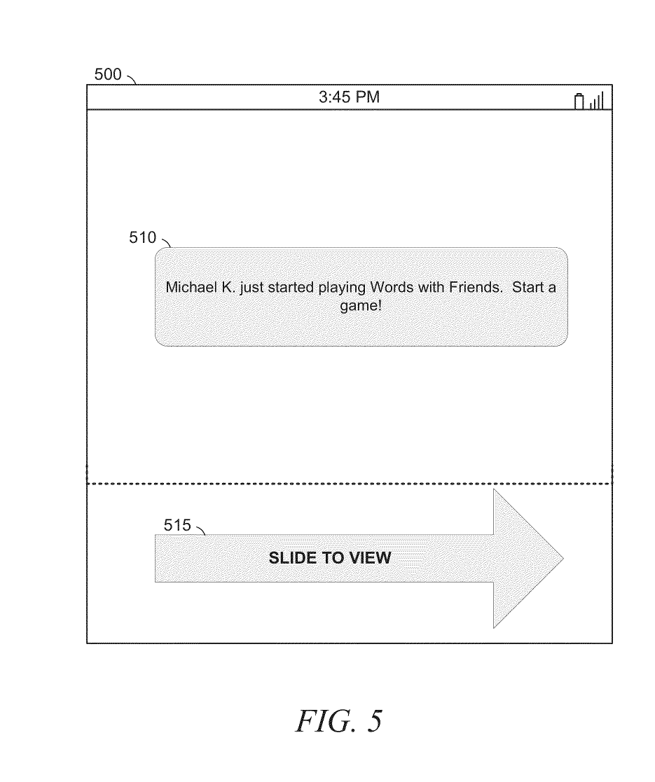

FIG. 5 is an example of a user interface of a client device, according to some example embodiments. FIG. 5 illustrates various aspects described by the steps of FIG. 4.

FIG. 5 illustrates user interface 500 displaying an online game notification 510 generated by the NG 150 and sent for display by the client device 130. The user interface 500 may be a lock screen of a wireless mobile device (i.e. smartphone) with a selectable icon 515 which, when selected, unlocks the user interface 500.

The NG 150 sends the online game notification 510 based on detecting a trigger event, such as Michael K.'s online gaming system account installation of an online game called “Words with Friends” offered by the game networking system 120b. Based on the detected installation of the online game, the NG 150 determines that Michael K.'s account is a new account on the game networking system 120b.

The NG 150 identifies a social network account that is a “friend” of Michael K's social network account. The NG 150 determines that the “friend” uses a social network system account to access “Words with Friends” on the game networking system 120b. The NG 150 determines the friend's social network system account is an additional account (i.e. target account) to which an invitation message to play “Words with Friends” against Michael K.'s new account will be sent.

The NG 150 identifies content for the online game notification 510 based on Michael K.'s account being a new account and the friend's account being a social network system account. The NG 150 customizes the online game notification 510 to include the following content: “Michael K. just started playing Words with Friends. Start a game!”

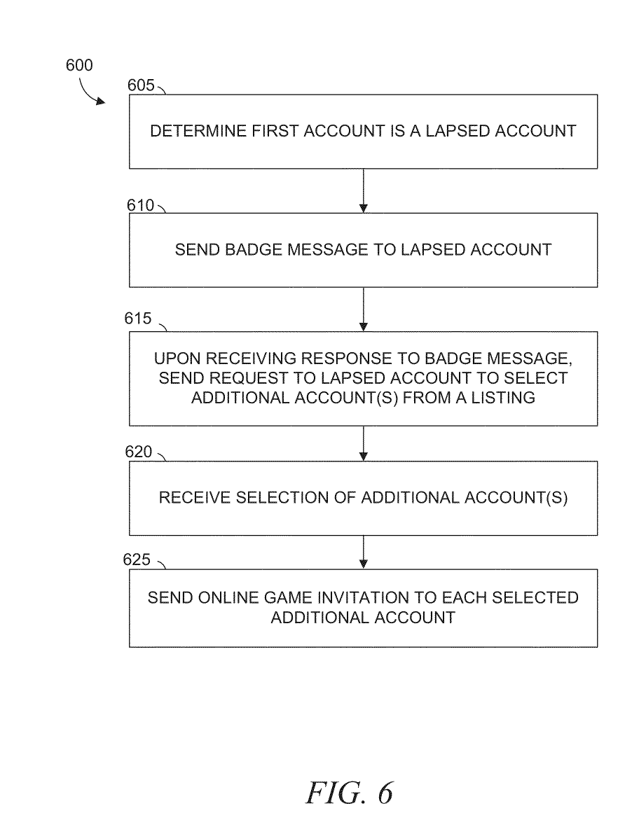

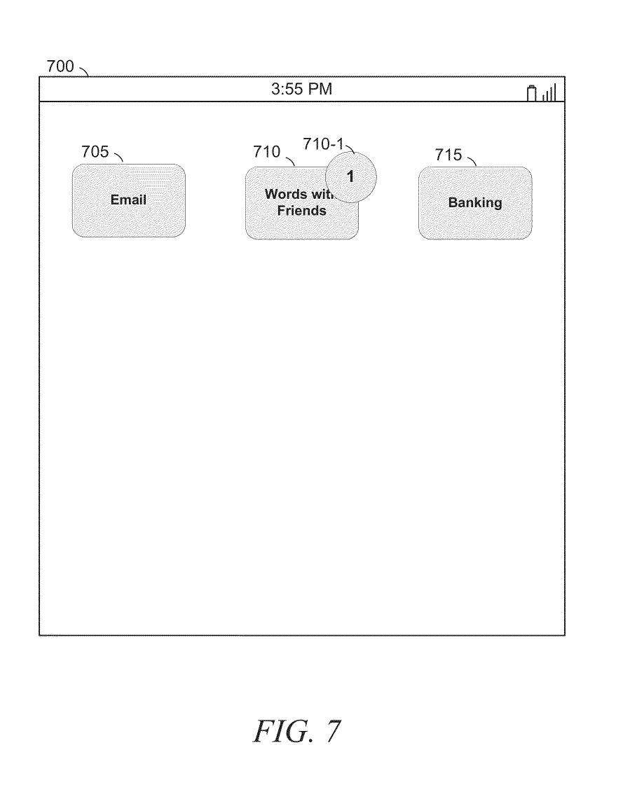

FIG. 6 is a flowchart showing an example method 600 of automatically sending a message to an additional account selected from a listing by a lapsed account, according to some example embodiments. The steps in method 600 describe operations that may be performed by the game networking system 120b. In addition, the discussion of the flowchart of FIG. 6 makes reference to aspects illustrated in FIGS. 7-9. FIGS. 7-9 are examples of user interfaces of a client device, according to some example embodiments.

At step 605, the NG 150 determines the first account is a lapsed account that last accessed the online game at a time prior to a predetermined time range. According to an example embodiment, the NG 150 detects the first account is a lapsed account because the first account hasn't played the online game in the past month, or week, or any since any predetermined period of time.

Upon determining the first account is a lapsed account, at step 610, the NG 150 automatically sends a badge message to the lapsed account. According to an example embodiment, the NG 150 sends a selectable indication, such as a selectable badge icon 710-1, that acts as a notification for a user of the lapsed account. As shown in FIG. 7, the selectable badge icon 710-1 can be generated by the NG 150 for display on a graphical user interface 700 of a mobile wireless device (e.g. a smartphone) associated with the lapsed account, where the graphical user interface displays a plurality of selectable icons 705, 710, 715, that represent various applications accessible by the mobile wireless device.

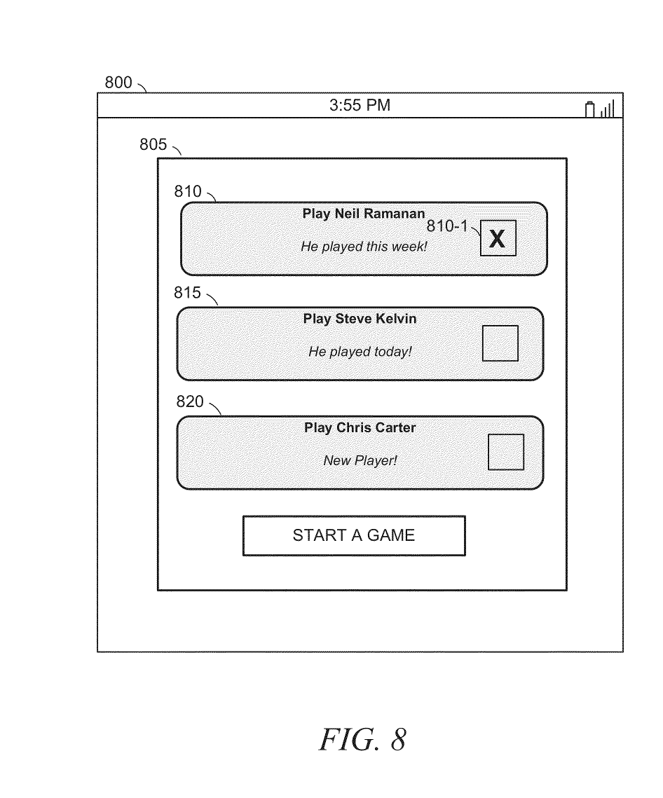

Upon receiving a response to the badge message, at step 615, the NG 150 sends a request to the first account for a selection of an additional account(s) (i.e. a target account(s)) from a listing of additional accounts. As illustrated by FIG. 8, the NG 150 creates a listing 805 of the identified additional accounts 810, 815, 820 for display on a graphical user interface 800 of a mobile wireless device associated with the lapsed account. The additional accounts 810, 815, 820 are identified according to account-type segments as described by the steps of flowchart 400.

The additional accounts 810, 820 displayed in the listing 805 may be respective social network accounts that access “Words with Friends”, whereas additional account 815 may be an online gaming system account that previously played “Words with Friends” against the lapsed account. The listing 805 includes a description of when each identified additional account 810, 815 last played “Words with Friends”. The listing 805 describes an additional account 820 as a new account “Words with Friends”.

At step 620, the NG 150 receives from the first account a selection of an additional account(s) from the listing. According to FIG. 8, the NG 150 will receive a response from the mobile wireless device representing a selection 801-1 of an additional account 810 against whom the lapsed account wishes to play “Words with Friends.”

At step 625, the NG 150 sends an instance of an online game invitation message to each additional account selected from the listing by the lapsed account. The NG 150 customizes the content of each invitation message according to the first account being a lapsed account and whether the selected additional account is a social network system account or an online gaming system account.

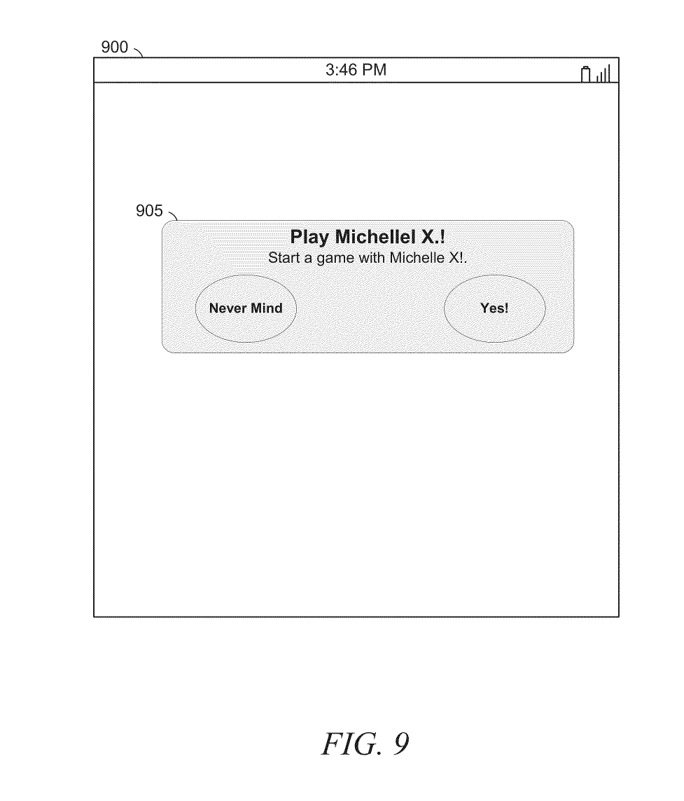

FIG. 9 illustrates a user interface 900 of a mobile wireless device associated with an additional account 810 selected by the lapsed account. The user interface 900 displays an online game invitation message 905 sent by the NG 150. In another embodiment, if the selected additional account is an online gaming system that previously played the online game against the lapsed account, the NG 150 customizes the invitation message with the following content: “When did you last play against <user_name>? Start a game now!” It is understood that the embodiments described herein are not limited to application to a “Words with Friends” game and can be utilized with any online game.

### Data Flow

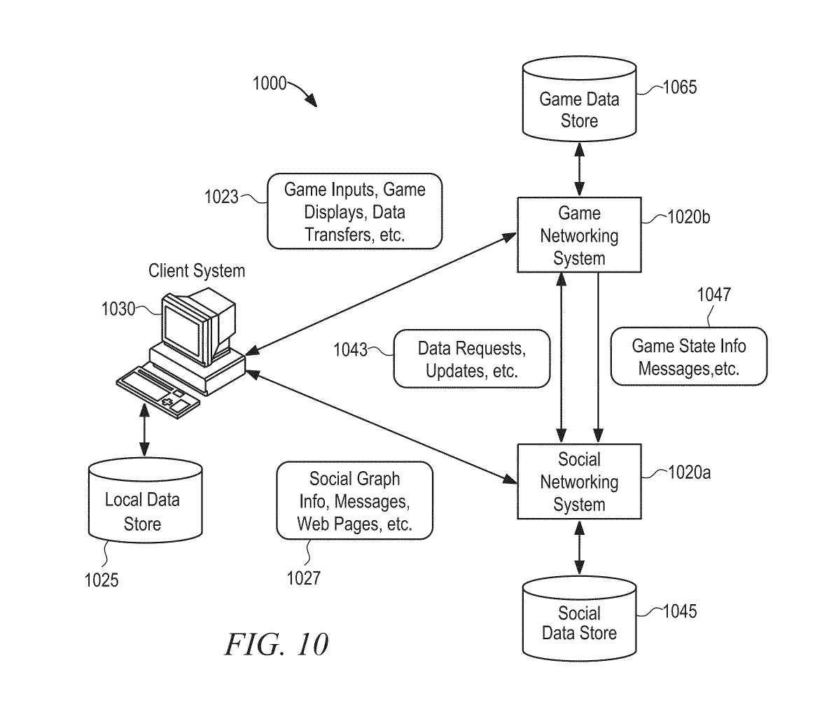

FIG. 10 illustrates an example data flow between the components of system 1000. In particular embodiments, system 1000 can include client system 1030, social networking system 1020a (i.e. social network system), and game networking system 1020b (i.e. online game system). The components of system 1000 can be connected to each other in any suitable configuration, using any suitable type of connection. The components may be connected directly or over any suitable network. Client system 1030, social networking system 1020a, and game networking system 1020b can each have one or more corresponding data stores such as local data store 1035, social data store 1045, and game data store 1065, respectively. Social networking system 1020a and game networking system 1020b can also have one or more servers that can communicate with client system 1030 over an appropriate network. Social networking system 1020a and game networking system 1020b can have, for example, one or more internet servers for communicating with client system 1030 via the Internet. Similarly, social networking system 1020a and game networking system 1020b can have one or more mobile servers for communicating with client system 1030 via a mobile network (e.g., GSM, PCS, Wi-Fi, WPAN, etc.). In some embodiments, one server may be able to communicate with client system 1030 over both the Internet and a mobile network. In other embodiments, separate servers can be used.

Client system 1030 can receive and transmit data 1023 to and from game networking system 1020b. This data can include, for example, webpages, messages, game inputs, game displays, HTTP packets, data requests, transaction information, updates, and other suitable data. At some other time, or at the same time, game networking system 1020b can communicate data 1043, 1047 (e.g., game state information, game system account information, page info, messages, data requests, updates, etc.) with other networking systems, such as social networking system 1020a (e.g., Facebook, Myspace, etc.). Client system 1030 can also receive and transmit data 1027 to and from social networking system 1020a. This data can include, for example, webpages, messages, social graph information, social network displays, HTTP packets, data requests, transaction information, updates, and other suitable data.

Communication between client system 1030, social networking system 1020a, and game networking system 1020b can occur over any appropriate electronic communication medium or network using any suitable communications protocols. For example, client system 1030, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols, may be used. In addition, a server in one interaction context may be a client in another interaction context. In particular embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 1020b, the BLOB containing the game state for the instance corresponding to the player can be transmitted to client system 1030 for use by a client-side executed object to process. In particular embodiments, the client-side executable may be a FLASH-based game, which can de-serialize the game state data in the BLOB. As a player plays the game, the game logic implemented at client system 1030 maintains and modifies the various game state parameters locally. The client-side game logic may also batch game events, such as mouse clicks, and transmit these events to game networking system 1020b. Game networking system 1020b may itself operate by retrieving a copy of the BLOB from a database or an intermediate memory cache (memcache) layer. Game networking system 1020b can also de-serialize the BLOB to resolve the game state parameters and execute its own game logic based on the events in the batch file of events transmitted by the client to synchronize the game state on the server side. Game networking system 1020b may then re-serialize the game state, now modified, into a BLOB and pass this to a memory cache layer for lazy updates to a persistent database.

With a client-server environment in which the online games may run, one server system, such as game networking system 1020b, may support multiple client systems 1030. At any given time, there may be multiple players at multiple client systems 1030 all playing the same online game. In practice, the number of players playing the same game at the same time may be very large. As the game progresses with each player, multiple players may provide different inputs to the online game at their respective client systems 1030, and multiple client systems 1030 may transmit multiple player inputs and/or game events to game networking system 1020b for further processing. In addition, multiple client systems 1030 may transmit other types of application data to game networking system 1020b.

In particular embodiments, a computed-implemented game may be a text-based or turn-based game implemented as a series of web pages that are generated after a player selects one or more actions to perform. The web pages may be displayed in a browser client executed on client system 1030. As an example and not by way of limitation, a client application downloaded to client system 1030 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a SWF object that is embedded in a web page and executable by a Flash media player plug-in. In particular embodiments, one or more described webpages may be associated with or accessed by social networking system 1020a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 1030, either caused by an action of a game player or by the game logic itself, client system 1030 may need to inform game networking system 1020b of the update. For example, if the game is a farming game with a harvest mechanic (such as Zynga FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 1000 is discussed in reference to updating a multi-player online game hosted on a network-addressable system (such as, for example, social networking system 1020a or game networking system 1020b), where an instance of the online game is executed remotely on a client system 1030, which then transmits application event data to the hosting system such that the remote game server synchronizes game state associated with the instance executed by the client system 1030.

In particular embodiment, one or more objects of a game may be represented as an Adobe Flash object. Flash may manipulate vector and raster graphics, and supports bidirectional streaming of audio and video. “Flash” may mean the authoring environment, the player, or the application files. In particular embodiments, client system 1030 may include a Flash client. The Flash client may be configured to receive and run Flash application or game object code from any suitable networking system (such as, for example, social networking system 1020a or game networking system 1020b). In particular embodiments, the Flash client may be run in a browser client executed on client system 1030. A player can interact with Flash objects using client system 1030 and the Flash client. The Flash objects can represent a variety of in-game objects. Thus, the player may perform various in-game actions on various in-game objects by make various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 1030, the Flash client may send the events that caused the game state changes to the in-game object to game networking system 1020b. However, to expedite the processing and hence the speed of the overall gaming experience, the Flash client may collect a batch of some number of events or updates into a batch file. The number of events or updates may be determined by the Flash client dynamically or determined by game networking system 1020b based on server loads or other factors. For example, client system 1030 may send a batch file to game networking system 1020b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 1030. In particular embodiments, the batch file may be a text file and the name-value pairs may be in string format.

In particular embodiments, when a player plays an online game on client system 1030, game networking system 1020b may serialize all the game-related data, including, for example and without limitation, game states, game events, user inputs, for this particular user and this particular game into a BLOB and stores the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, game networking system 1020b may retrieve the corresponding BLOB from the database to determine the most-recent values of the game-related data. In particular embodiments, while a player is playing the online game, game networking system 1020b may also load the corresponding BLOB into a memory cache so that the game system may have faster access to the BLOB and the game-related data contained therein.

### Systems and Methods

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

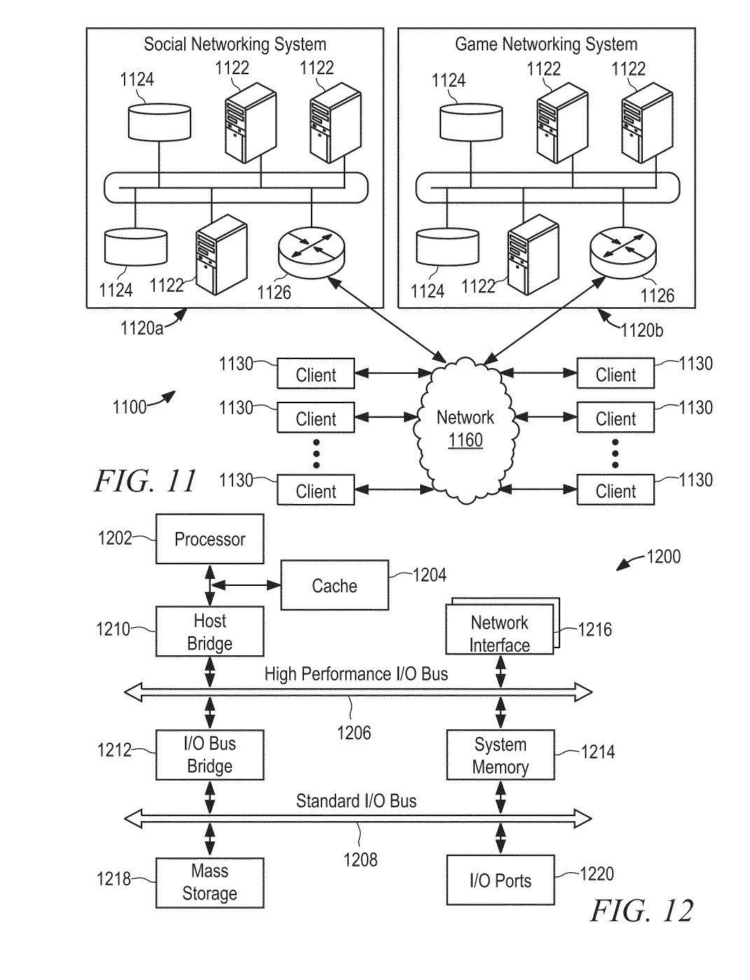

Particular embodiments may operate in a wide area network environment, such as the Internet, including multiple network addressable systems. FIG. 11 illustrates an example network environment, in which various example embodiments may operate. Network cloud 1160 generally represents one or more interconnected networks, over which the systems and hosts described herein can communicate. Network cloud 1160 may include packet-based wide area networks (such as the Internet), private networks, wireless networks, satellite networks, cellular networks, paging networks, and the like. As FIG. 11 illustrates, particular embodiments may operate in a network environment comprising one or more networking systems, such as social networking system 1120a, game networking system 1120b, and one or more client systems 1130. The components of social networking system 1120a and game networking system 1120b operate analogously; as such, hereinafter they may be referred to simply at networking system 1120. Client systems 1130 are operably connected to the network environment via a network service provider, a wireless carrier, or any other suitable means.

Networking system 1120 is a network addressable system that, in various example embodiments, comprises one or more physical servers 1122 and data stores 1124. The one or more physical servers 1122 are operably connected to computer network 1160 via, by way of example, a set of routers and/or networking switches 1126. In an example embodiment, the functionality hosted by the one or more physical servers 1122 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like.

Physical servers 1122 may host functionality directed to the operations of networking system 1120. Hereinafter servers 1122 may be referred to as server 1122, although server 1122 may include numerous servers hosting, for example, networking system 1120, as well as other content distribution servers, data stores, and databases. Data store 1124 may store content and data relating to, and enabling, operation of networking system 1120 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Logically, data store 1124 corresponds to one or more of a variety of separate and integrated databases, such as relational databases and object-oriented databases, that maintain information as an integrated collection of logically related records or files stored on one or more physical systems. Structurally, data store 1124 may generally include one or more of a large class of data storage and management systems. In particular embodiments, data store 1124 may be implemented by any suitable physical system(s) including components, such as one or more database servers, mass storage media, media library systems, storage area networks, data storage clouds, and the like. In one example embodiment, data store 1124 includes one or more servers, databases (e.g., MySQL), and/or data warehouses. Data store 1124 may include data associated with different networking system 1120 users and/or client systems 1130.

Client system 1130 is generally a computer or computing device including functionality for communicating (e.g., remotely) over a computer network. Client system 1130 may be a desktop computer, laptop computer, personal digital assistant (PDA), in- or out-of-car navigation system, smart phone or other cellular or mobile phone, or mobile gaming device, among other suitable computing devices. Client system 1130 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 1130 to enter addresses of specific network resources to be retrieved, such as resources hosted by networking system 1120. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 1130 desires to view a particular webpage (hereinafter also referred to as target structured document) hosted by networking system 1120, the user's web browser, or other document rendering engine or suitable client application, formulates and transmits a request to networking system 1120. The request generally includes a URL or other document identifier as well as metadata or other information. By way of example, the request may include information identifying the user, such as a user ID, as well as information identifying or characterizing the web browser or operating system running on the user's client computing device 1130. The request may also include location information identifying a geographic location of the user's client system or a logical network location of the user's client system. The request may also include a timestamp identifying when the request was transmitted.

Although the example network environment described above and illustrated in FIG. 11 described with respect to social networking system 1120a and game networking system 1120b, this disclosure encompasses any suitable network environment using any suitable systems. As an example and not by way of limitation, the network environment may include online media systems, online reviewing systems, online search engines, online advertising systems, or any combination of two or more such systems.

FIG. 12 illustrates an example computing system architecture, which may be used to implement a server 1122 or a client system 1130. In one embodiment, hardware system 1200 comprises a processor 1202, a cache memory 1204, and one or more executable modules and drivers, stored on a tangible computer readable medium, directed to the functions described herein. Additionally, hardware system 1200 may include a high performance input/output (I/O) bus 1206 and a standard I/O bus 1208. A host bridge 1210 may couple processor 1202 to high performance I/O bus 1206, whereas I/O bus bridge 1212 couples the two buses 1206 and 1208 to each other. A system memory 1214 and one or more network/communication interfaces 1216 may couple to bus 1206. Hardware system 1200 may further include video memory (not shown) and a display device coupled to the video memory. Mass storage 1218 and I/O ports 1220 may couple to bus 1208. Hardware system 1200 may optionally include a keyboard, a pointing device, and a display device (not shown) coupled to bus 1208. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 1200 are described in greater detail below. In particular, network interface 1216 provides communication between hardware system 1200 and any of a wide range of networks, such as an Ethernet (e.g., IEEE 802.3) network, a backplane, etc. Mass storage 1218 provides permanent storage for the data and programming instructions to perform the above-described functions implemented in servers 422, whereas system memory 1214 (e.g., DRAM) provides temporary storage for the data and programming instructions when executed by processor 1202. I/O ports 1220 are one or more serial and/or parallel communication ports that provide communication between additional peripheral devices, which may be coupled to hardware system 1200.

Hardware system 1200 may include a variety of system architectures and various components of hardware system 1200 may be rearranged. For example, cache 1204 may be on-chip with processor 1202. Alternatively, cache 1204 and processor 1202 may be packed together as a “processor module,” with processor 1202 being referred to as the “processor core.” Furthermore, certain embodiments of the present disclosure may not require nor include all of the above components. For example, the peripheral devices shown coupled to standard I/O bus 1208 may couple to high performance I/O bus 1206. In addition, in some embodiments, only a single bus may exist, with the components of hardware system 1200 being coupled to the single bus. Furthermore, hardware system 1200 may include additional components, such as additional processors, storage devices, or memories.

An operating system manages and controls the operation of hardware system 1200, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft (r) Windows(r) operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

### Miscellaneous

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related virtual objects (such as stores and restaurants), the invention can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method, comprising:
detecting online game activity of a first account in an online game;
in an automated operation using one or more processors, identifying an additional account associated with the online game;
identifying message content based on the detected online game activity and the additional account;
populating a message with the message content; and
sending the message to the additional account.

2. The computer-implemented method as in claim 1, wherein detecting online game activity of a first account comprises:
detecting an installation of the online game by the first account; and
determining the first account is a new account comprising an account that has never previously accessed the online game.

3. The computer-implemented method as in claim 1, wherein detecting online game activity of a first account comprises:
determining the first account is a lapsed account comprising an account that last accessed the online game at a time prior to a predetermined time range.

4. The computer-implemented method as in claim 1, identifying an additional account further comprises:
identifying at least one segment of account types comprising:
identifying at least one of: (i) a first segment including at least one social network system account that accesses the online game on an online gaming system and (ii) a second segment including at least one online gaming system account stored on the online gaming system.

5. The computer-implemented method as in claim 4, wherein identifying message content based on the detected online game activity and the additional account:
identifying segment-specific message content, which comprises:
(i) identifying first segment content when a respective identified additional account is a social network system account; and
(ii) identifying second segment content when a respective identified additional account is an online gaming system account, wherein the first segment content differs from the second segment content; and
wherein populating a message with the message content comprises: including one of the first segment content and the second segment content as at least part of the message content for an instance of an online game invitation to be sent to the respective identified additional account.

6. The computer-implemented method as in claim 4, comprises:
wherein identifying a first segment including at least one social network system account that accesses the online game on an online gaming system comprises: identifying a respective social network system account having a connection to a social network system account that corresponds with the first account; and
wherein identifying a second segment including at least one online gaming system account stored on the online gaming system comprises at least one of: (i) identifying a respective online gaming system account that previously played the online game with the first account and (ii) identifying a respective online gaming system account that has a social graph connection with the first account in a social graph of online gaming system accounts within the online gaming system.

7. The computer-implemented method as in claim 4 comprising:
upon determining the first account is a lapsed account comprising an account that last accessed the online game at a time prior to a predetermined time range:
sending a badge message to the lapsed account;
wherein identifying an additional account further comprises:
(i) upon receiving a response to the badge message, sending a request to the first account for a selection of at least one additional account from a listing of respective, identified additional accounts; and
(ii) receiving from the first account a selection of at least one additional account from the listing; and
wherein sending the message to the additional account comprises: sending an instance of an online game invitation message to each additional account selected from the listing by the lapsed account.

8. A non-transitory computer-readable medium storing executable instructions thereon, which, when executed by a processor, cause the processor to perform operations including:
detecting online game activity of a first account in an online game;
identifying an additional account associated with the online game;
identifying message content based on the detected online game activity and the additional account;
populating a message with the message content; and
sending the message to the additional account.

9. The non-transitory computer-readable medium as in claim 8, wherein detecting online game activity of a first account comprises:
detecting an installation of the online game by the first account; and
determining the first account is a new account comprising an account that has never previously accessed the online game.

10. The non-transitory computer-readable medium as in claim 8, wherein detecting online game activity of a first account comprises:
determining the first account is a lapsed account comprising an account that last accessed the online game at a time prior to a predetermined time range.

11. The non-transitory computer-readable medium as in claim 8, identifying an additional account further comprises:
identifying at least one segment of account types comprising:
identifying at least one of: (i) a first segment including at least one social network system account that accesses the online game on an online gaming system and (ii) a second segment including at least one online gaming system account stored on the online gaming system.

12. The non-transitory computer-readable medium as in claim 11, wherein identifying message content based on the detected online game activity and the additional account:
identifying segment-specific message content, which comprises:
(i) identifying first segment content when a respective identified additional account is a social network system account; and
(ii) identifying second segment content when a respective identified additional account is an online gaming system account, wherein the first segment content differs from the second segment content; and
wherein populating a message with the message content comprises: including one of the first segment content and the second segment content as at least part of the message content for an instance of an online game invitation to be sent to the respective identified additional account.

13. The non-transitory computer-readable medium as in claim 11, comprises:
wherein identifying a first segment including at least one social network system account that accesses the online game on an online gaming system comprises: identifying a respective social network system account having a connection to a social network system account that corresponds with the first account; and
wherein identifying a second segment including at least one online gaming system account stored on the online gaming system comprises at least one of: (i) identifying a respective online gaming system account that previously played the online game with the first account and (ii) identifying a respective online gaming system account that has a social graph connection with the first account in a social graph of online gaming system accounts within the online gaming system.

14. The non-transitory computer-readable medium as in claim 11, comprising:
upon determining the first account is a lapsed account comprising an account that last accessed the online game at a time prior to a predetermined time range:
sending a badge message to the lapsed account;
wherein identifying an additional account further comprises:
(i) upon receiving a response to the badge message, sending a request to the first account for a selection of at least one additional account from a listing of respective, identified additional accounts; and
(ii) receiving from the first account a selection of at least one additional account from the listing; and
wherein sending the message to the additional account comprises:
sending an instance of an online game invitation message to each additional account selected from the listing by the lapsed account.

15. A computer system comprising:
a processor;
a memory device holding an instruction set executable on the processor to cause the computer system to perform operations comprising:
detecting online game activity of a first account in an online game;
identifying an additional account associated with the online game;
identifying message content based on the detected online game activity and the additional account;
populating a message with the message content; and
sending the message to the additional account.

16. The computer system as in claim 15, wherein detecting online game activity of a first account comprises:
detecting an installation of the online game by the first account; and
determining the first account is a new account comprising an account that has never previously accessed the online game.

17. The computer system as in claim 15, wherein detecting online game activity of a first account comprises:
determining the first account is a lapsed account comprising an account that last accessed the online game at a time prior to a predetermined time range.

18. The computer system as in claim 15, identifying an additional account further comprises:
identifying at least one segment of account types comprising:
identifying at least one of: (i) a first segment including at least one social network system account that accesses the online game on an online gaming system and (ii) a second segment including at least one online gaming system account stored on the online gaming system.

19. The computer system as in claim 18, wherein identifying message content based on the detected online game activity and the additional account:
identifying segment-specific message content, which comprises:
(i) identifying first segment content when a respective identified additional account is a social network system account; and
(ii) identifying second segment content when a respective identified additional account is an online gaming system account, wherein the first segment content differs from the second segment content; and
wherein populating a message with the message content comprises: including one of the first segment content and the second segment content as at least part of the message content for an instance of an online game invitation to be sent to the respective identified additional account.

20. The computer system as in claim 18, comprises:
wherein identifying a first segment including at least one social network system account that accesses the online game on an online gaming system comprises: identifying a respective social network system account having a connection to a social network system account that corresponds with the first account; and
wherein identifying a second segment including at least one online gaming system account stored on the online gaming system comprises at least one of: (i) identifying a respective online gaming system account that previously played the online game with the first account and (ii) identifying a respective online gaming system account that has a social graph connection with the first account in a social graph of online gaming system accounts within the online gaming system.

21. The computer system as in claim 18 comprising:
upon determining the first account is a lapsed account comprising an account that last accessed the online game at a time prior to a predetermined time range:
sending a badge message to the lapsed account;
wherein identifying an additional account further comprises:
(i) upon receiving a response to the badge message, sending a request to the first account for a selection of at least one additional account from a listing of respective, identified additional accounts; and
(ii) receiving from the first account a selection of at least one additional account from the listing; and
wherein sending the message to the additional account comprises: sending an instance of an online game invitation message to each additional account selected from the listing by the lapsed account.

22. A computer-implemented method, comprising:
detecting a predefined trigger activity for a first account in an online game;
in an automated operation using one or more processors, identifying, based on predefined targeting criteria, a target account associated with the first account;
identifying message content based at least in part on the predefined trigger activity and the identified target account;
populating a message with the message content; and
sending the message to the additional account.
